(19) United States
(12) Patent Application Publication
(10) Pub. No.: US 2006/0008763 A1
(43) Pub. Date: Jan. 12, 2006

(54) Device and arrangement for fixture installation

(76) Inventor: Izidor Brajnovic, Goteborg (SE)

Correspondence Address: KNOBBE MARTENS OLSON & BEAR LLP, 2040 MAIN STREET, FOURTEENTH FLOOR, IRVINE, CA, 92614, US

(21) Appl. No.: 11/172,291

(22) Filed: Jun. 30, 2005

Related U.S. Application Data
(63) Continuation of application No. PCT/SE03/01975, filed on Dec. 17, 2003.

(30) Foreign Application Priority Data
Dec. 30, 2002 (SE) SE 0203898-2

(51) Int. Cl. A61C 3/02; A61C 8/00

(52) U.S. Cl. 433/76; 433/173

(57) ABSTRACT

A device and arrangement for installation of a fixture in a jaw bone comprises a fixture holder designed to cooperate with a guide member forming part of a template, via which guide member the fixture can be applied in its position in the jaw bone with the aid of the fixture holder. The arrangement is also provided with one or more elements which, with the aid of the guide member, ensure defined positions of the fixture in the vertical and transverse directions. The element or elements is or are arranged on the fixture holder.

### PRIORITY INFORMATION

This application is a continuation of International Application PCT/SE2003/001975, with an international filing date of Dec. 17, 2003, which claims priority under 35 U.S.C. § 119 to Swedish Patent Application No. SE 0203898-2, filed Dec. 30, 2002, the entire contents of both of applications are expressly incorporated by reference herein.

### BACKGROUND OF THE INVENTION

1. Field of the Invention

The present invention relates to a device and arrangement for installation of a fixture in a jaw bone. The invention also relates to an arrangement for installation of two or more fixtures which can be installed in the jaw bone in a corresponding manner.

2. Description of the Related Art and Summary of the Invention

Embodiments of the present invention re intended to be used in, among other things, the arrangement sold by Nobel Biocare AB for ARK operations (Absolute Rehabilitation Kit). Reference is made, inter alia, to the PCT applications WO 02/053055 A1, WO 02/053056 A1 and WO 02/053057 A1 filed by the same Applicant and with the same inventor as for the present patent application.

It is already known, in existing installation arrangements, to use a device which functions as a separate unit and by means of which the fixtures are applied in their necessary and correct positions in the vertical direction and the transverse directions (tilt direction). In installation work performed by practiced doctors, it sometimes happens that the separate device is not used, which means there is a risk that the necessarily precise positions of the fixtures in the jaw bone will not be obtained. Without using the separate device (fixture guide), the fixtures can easily end up in positions which are too deep, with the result that the produced bridge which is to be applied to the fixtures does not fit them. It is also easy for the fixtures to be pulled obliquely, for example if the bone structure in the formed hole does not have the same density throughout. This too can result in poor or impossible fitting of the dental bridge which is to be installed. Embodiments of the present invention aim to solve these problems inter alia.

In fixture installations using previously known auxiliary devices, problems can also arise if the installation work is drawn out over time. The known separate device has an application and function which mean that the previously used fixture holder must first be removed before the necessary removal of the separate device could take place. Given said time consideration, this means that soft tissue parts of the jaw bone can start to grow over the implant in a relatively short time, so that these become difficult to identify in the subsequent bridge installation work. Embodiments of the invention also solve this problem.

Embodiments of the present invention comprise a device mentioned at the outset is that an element or elements is or are arranged on the fixture holder itself. In a preferred embodiment, there is a first element in the form of an outwardly protruding stop member which, when the fixture is at its defined position in the vertical direction, can be applied against a top surface of the guide member of the template. The stop member can have the form of an outwardly protruding flange. In one embodiment, the fixture holder can have a part which protrudes above the template and guide member, and by means of which or via which the fixture and the fixture holder are held together by a screw in a rotatable manner. A second element can be in the form of a part having an outer surface arranged to cooperate with an opposite inner surface of the guide member in order to define the transverse position of the fixture. The compulsory application of the fixture holder in the fixture installation in this way guarantees the precisely defined positions of the fixture in the vertical and transverse directions in the jaw bone. The fixture can also be designed so that, in the position in which it gives the fixture defined positions in the vertical and transverse directions, it can be left there for a time preventing jaw bone, for example the soft tissue of the jaw bone, from growing over what would otherwise be an exposed fixture end.

In another embodiment of the present invention, an arrangement of the type mentioned at the outset includes fixture holders for two or more fixtures each have their own element or elements.

Further embodiments of the present invention are set out in the attached dependent claims which refer back to the independent arrangement claim.

Another embodiment of the present invention comprises a fixture holder designed to cooperate with a guide member forming part of a template, via which guide member the fixture can be applied in its position in the jaw bone with the aid of the fixture holder. The arrangement is also provided with one or more elements which, with the aid of the guide member, ensure defined positions of the fixture in the vertical and transverse directions.

By what has been proposed above, the aforementioned problems are given technically simple solutions which exclude the omission of the necessary functions of vertical and transverse direction determination. The new components can easily be incorporated in the already existing techniques, thus avoiding reconfiguration and extra costs.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

Presently proposed embodiments of the invention will be described below with reference to the attached drawing, in which:

FIG. 1 shows a longitudinal section through a fixture applied in a jaw bone with the aid of a fixture holder which has members for defining the position of the fixture in the vertical and transverse directions.

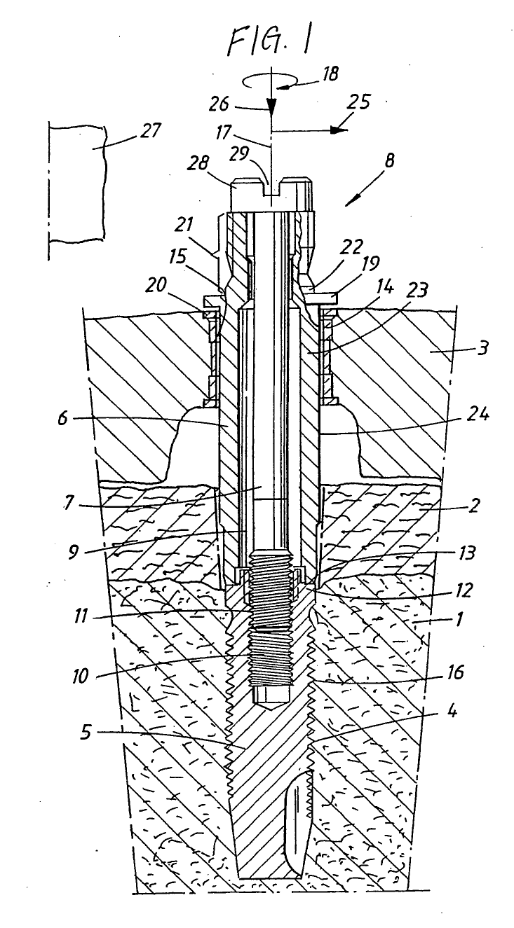

### DETAILED DESCRIPTION OF THE PREFERRED EMBODIMENTS

In the figure, reference number 1 designates a jaw bone, and reference number 2 designates gum (mucosa) or soft tissue. A template of a type known per se is arranged on top of the soft tissue, in which connection reference may be made to the PCT specifications mentioned above. A hole/drilled hole 4 has been formed in the jaw bone in a manner known per se. A fixture 5 has been applied in the hole, and the application has been performed with the aid of a fixture holder 6 which assumes an assembled state with the fixture, which state has been obtained with the aid of a screw 7 extending from the upper parts 8 of the fixture holder, through the fixture holder in an inner recess 9 formed therein, and down into a thread 10 in the fixture. The screw 7 is provided with an outer thread 11 via which the screw can be screwed into the thread 10 of the fixture which is an inner thread. The fixture is provided with an upper flange 12 against which an end surface 13 of the fixture holder 6 can be applied. This application means that the jaw bone or dentine 1, 2 cannot grow in across the fixture end which is directed upward toward the fixture holder. The template 3 comprises a guide member in the form of a sleeve 14 which is provided with a recess 15. In the assembled state with the fixture holder 6, the implant can be applied in its position in the drilled hole 4 via the recess 15. The fixture is provided with an outer thread which can cooperate with the wall of the drilled hole 4 upon simultaneous rotation of the assembled fixture and fixture holder. The rotation takes place about the assembled unit 5, 6. The rotation takes place in a clockwise direction of rotation 18 when screwing into the jaw bone.

In accordance with an embodiment of the invention, the fixture holder is provided with elements in the form of a stop member 19 which can consist of an outwardly protruding flange. When the implant has been screwed in to its full extent, the stop member cooperates with a top surface of a flange 20 on said sleeve-like guide member. The cooperation between the flanges 19 and 20 means that a stop is provided for the degree of screwing of the fixture into the jaw bone 1. The part of the fixture holder protruding above the flange 19 is designated by 21. Said part 21 can be provided with a wrench grip 22 so that the fixture can be screwed into the jaw bone easily. The fixture holder is also provided with a part 23 which has an outer surface which can cooperate with the inner surface 15 of the guide member 14. The last-mentioned cooperation is thus such that there is precision in the transverse direction 25 or tilt direction of the assembled unit 5, 6. The stop member 19 ensures the fixture's precise positioning in the vertical direction, which has been indicated by 26 in the figure.

By the above described embodiment, the fixture 5 can be assigned an exact position in the vertical direction and transverse direction. The play between the surfaces 15 and 24 is extremely small, for example 0.05 mm. The stop member 1 and the sleeve 14 function with corresponding precision. When the fixture, after its application, has fused with the jaw bone, the holder 6 can be removed by undoing the screw 7 from the thread 10. In bridge installations there are two or more fixtures 5, and a preferred embodiment is one in which the fixture holder is left in place at all installation points until the last installation has been completed. Removal of the fixture holders can be done in a short time which, for example, avoids gum 2 growing in across the end surface 12 of the respective fixture. Upon removal of the fixture holders, the template is also removed and a bridge, indicated symbolically by 27, can be placed in a manner known per se on the fixtures. In one embodiment there are two or more fixture installations of the type shown in the figure. As the installations can look the same or similar, only one installation has been shown in the figure. The screw 7 is provided, likewise in a manner known per se, with a screw head 28 and a screwdriver slot 29, and the screw head lies with its underside against a top surface of the upwardly protruding part 21. By the embodiments described above, it is possible to apply the finished bridge immediately after the fixtures have been installed, even though osteointegration may take several months. By the embodiments described above, the outer shape of the fixture holder can be adapted so that it corresponds to the previously used separate unit (fixture guide) and can be guided through the sleeve of the template right down to the bottom. The problem of the fixture possibly lying too deep and of the bridge not fitting is solved in accordance with the above because it is not possible to install the fixture without the fixture holder.

Although the foregoing systems and methods have been described in terms of certain preferred embodiments, other embodiments will be apparent to those of ordinary skill in the art from the disclosure herein. Additionally, other combinations, omissions, substitutions and modifications will be apparent to the skilled artisan in view of the disclosure herein. While certain embodiments of the inventions have been described, these embodiments have been presented by way of example only, and are not intended to limit the scope of the inventions. Indeed, the invention is not limited to the embodiment shown above by way of example, and instead it can be modified within the scope of the attached patent claims and the inventive concept.

What is claimed is:

1. A device and arrangement for installation of a fixture in a jaw bone, the device comprising a fixture holder configured to cooperate with a guide member that forms part of a template, via which the guide member and the fixture can be applied in its position in the jaw bone with the aid of the fixture holder, and, at least one element, configured with the aid of the guide member, to ensure defined positions of the fixture in the vertical and transverse directions, wherein the at least one element is on the fixture holder.

2. The device as in claim 1, wherein the at least one element comprises a first element that has the form of an outwardly protruding stop member which, when the fixture is at its defined position in the vertical direction can be applied against a top surface of the guide member.

3. The device as in claim 2, wherein the stop member has the form of an outwardly protruding flange.

4. The device as in claim 1, wherein the fixture holder has a part which protrudes above the template and guide member, and through which the fixture and the fixture holder are held together by a screw in a rotatable manner.

5. The device as in claim 2, wherein the at least one element comprises a second element in the form of a part having an outer surface that is arranged to cooperate with an opposite inner surface of the guide member in order to define the transverse position.

6. The device as in claim 1, wherein the compulsory application of the fixture holder in the fixture installation guarantees the defined positions of the fixture in the vertical and transverse directions in the jaw bone.

7. The device as in claim 1, wherein the fixture holder is configured so that, in the position in which it gives the fixture defined positions in the vertical and transverse directions, it can be left there for a time preventing jaw bone from growing over what would otherwise be an exposed fixture end.

8. An arrangement for installation of two or more fixtures, the arrangement comprising, for each fixture, a fixture holder configured to cooperate with a guide member that forms part of a template, via which the guide member and the fixture can be applied in its position in the jaw bone with the aid of the fixture holder, and one or more elements which are configured with the aid of the guide member, to ensure defined positions of the fixture in the vertical and transverse directions, wherein all of the fixture holders each have their own respective one or more elements.

9. The arrangement as in claim 8, wherein the fixture holders are configured so that, in the positions in which they give the fixtures defined positions in the vertical and transverse directions, they can be left there for a time causing jaw bon, to grow over what would otherwise be exposed fixture ends.

10. The arrangement as in claim 9, wherein all the fixture holders are detachable and a final bridge installation can be applied within a period in which there is no time for overgrowing of the jaw bone/soft tissue to take place, making it easy to identify application points for the bridge installation.
